(19) United States
(12) Patent Application Publication
(10) Pub. No.: US 2009/0081096 A1
(43) Pub. Date: Mar. 26, 2009

(54) Method and means for capture and long-term sequestration of carbon dioxide

(76) Inventor: Roy J. Pellegrin, Wailuku, HI (US)

Correspondence Address: Bruce H. Johnsonbaugh Eckhoff & Hoppe, Suite 2800, 101 Montgomery Street, San Francisco, CA, 94104, US

(21) Appl. No.: 12/313,702

(22) Filed: Nov. 24, 2008

Related U.S. Application Data
(63) Continuation-in-part of application No. 11/729,253, filed on Mar. 28, 2007.
(60) Provisional application No. 61/004,446, filed on Nov. 27, 2007.
(60) Provisional application No. 61/007,213, filed on Dec. 11, 2007.

(51) Int. Cl. B01D 53/62

(52) U.S. Cl. 423/232; 422/168

(57) ABSTRACT

The invention teaches a practical method of recovering CO₂ from a mixture of gases, and sequestering the captured CO₂ from the atmosphere for geologic time as calcium carbonate and provides a CO₂ scrubber for carbon capture and sequestration. CO₂ from the production of calcium oxide is geologically sequestered. A calcium hydroxide solution is produced from the environmentally responsibly-produced calcium oxide. The CO₂ scrubber incorporates an aqueous froth to maximize liquid-to-gas surface area and time-of-contact between gaseous CO₂ and the calcium hydroxide solution. The CO₂ scrubber decreases the temperature of the liquid and the mixed gases, increases ambient pressure on the bubbles and vapor pressure inside the bubbles, diffuses the gas through intercellular walls from relative smaller bubbles with relative high vapor pressure into relative larger bubbles with relative low vapor pressure, and decreases the mean-free-paths of the CO₂ molecules inside the bubbles, in order to increase solubility of CO₂ and the rate of dissolution of gaseous CO₂ from a mixture of gases into the calcium hydroxide solution.

The CO₂ scrubber recovers gaseous CO₂ directly from the atmosphere, from post-combustion flue gas, or from industrial processes that release CO₂ as a result of process. CO₂ reacts with calcium ions and hydroxide ions in solution forming insoluble calcium carbonate precipitates. The calcium carbonate precipitates are separated from solution, and sold to recover at least a portion of the cost of CCS.

### CROSS-REFERENCE TO RELATED APPLICATIONS

This is a Continuation-in-Part of U.S. patent application Ser. No. 11/729,253 filed Mar. 28, 2007. This application claims the benefit of and priority from the following United States provisional applications:

1) U.S. Ser. No. 61/004,446, filed Nov. 27, 2007

2) U.S. Ser. No. 61/007,213, filed Dec. 11, 2007

### BACKGROUND AND SUMMARY OF INVENTION

The Intergovernmental Panel on Climate Change (IPCC) has related the rise in average global temperature to the rising carbon dioxide (CO₂) concentration in Earth's atmosphere. The anthropogenic burning of fossil fuels, and subsequent release of CO₂, has been correlated as one of the factors contributing to the current rate of average global temperature increase.

A practical solution to Carbon Capture and Sequestration (CCS) would take an abundant natural resource, combine the natural resource with CO₂ to create a commodity that can be recycled back into production or sold to offset the cost of CCS, while providing long-term sequestration of CO₂ from the atmosphere.

Calcium, the fifth most abundant element by mass in the Earth's crust, is also one of the most widely distributed minerals on the Earth's surface. In nature, calcium reacts with oxygen (O₂) forming unstable calcium oxide. Calcium oxide reacts rapidly on contact with carbon dioxide (CO₂), forming very stable calcium carbonate (CaCO₃).

Being unstable, calcium oxide does not occur in nature, but must be synthetically produced. Calcium oxide is produced by heating limestone to sublimate CO₂ from the calcium carbonate to form calcium oxide and gaseous CO₂. For the CCS process described herein, the gaseous CO₂ that is released during the production of calcium oxide is geologically sequestered. The calcium oxide that has been responsibly produced, from an environmental perspective, is transported from the site of production, to the site of CCS.

Calcium oxide, when slaked with water, forms calcium hydroxide (Ca(OH)₂). Calcium hydroxide, when dissolved in water, dissociates into calcium ions (Ca++) and hydroxide ions (OH−). When CO₂ comes into contact with calcium ions and hydroxide ions in solution, insoluble, and very stable calcium carbonate (CaCO₃) precipitates out of solution.

Calcium carbonate precipitants are used as an extender in paints, filler in plastics, for acidic soil and water neutralization, slope stabilization, as flow-able fill, mineral filler, and admix for Portland cement. Calcium carbonate (limestone) mineral filler increases the strength-of-bond between the aggregate and the cement in concrete mix; increasing load-bearing capacity, wear resistance, and reducing the permeability of the concrete for construction of roadways, runways and taxi-ways, bridges, dams and reservoirs. Limestone mineral filler has been used extensively for such applications as ready-mixed, precast, and self-consolidating concrete. Limestone mineral filler produces a consistently white product because of its pure calcium carbonate composition, making limestone filler ideal for precast or architectural cast-in-place concrete products. Limestone is commonly processed into two different grades—3 and 10—with particle sizes ranging from 1.4-3.2 microns and 3.2-10 microns. Limestone mineral filler particles from CO₂ scrubbers are also smaller in diameter than the typical Type 1 Portland cement aggregate diameter, resulting in savings through lesser cementateous material requirements.

In 2005, global production of hydraulic cement was 2.3 billion metric tons. After water, cement is the second most-used commodity by humans.

### FIELD OF THE INVENTION

Generally, the present invention relates to CO₂ capture and sequestration. Specifically, the present invention describes a unique bubble-column reactor/scrubber and teaches a novel process for efficient separation of CO₂ from a mixture of gases, and mineral sequestration of the captured CO₂.

### PRIOR ART

In U.S. Pat. No. 6,872,240 entitled “Method and Apparatus for Filtering an Air Stream using an Aqueous Froth together with Nucleation” issued Mar. 29, 2005, Pellegrin describes an aqueous-froth air (AFA) filter, and teaches that “the incoming air stream is saturated with a fine mist generated with specially designed fogger nozzles that quickly supersaturate the incoming air stream” and “the controlled conditions inside the filter enable smaller micro-droplet and vapor formation without the limiting, counteracting effects of evaporation found in nature”. The bubbles are cooled on “cold, preferably metal surfaces”, and the key operational point was highlighted that “sub-micron contaminants in the air acted as condensation nuclei causing heterogeneous nucleation, effectively encasing the contaminants in an airborne fluid aerosol.”

In the scaled-up alternative embodiment of the prior art AFA filter with nucleation (see FIG. 10 of U.S. Pat. No. 6,872,240), the bubbles are created at the bottom of the column of bubbles, beneath the surface of the liquid reservoir, and travel in an upward direction through the column of bubbles. The ambient pressure on the bubble and the vapor pressure inside the bubble is continuously reduced as the bubble travels upward through, or with, the column of bubbles. Increased pressure on, or inside the bubble is therefore, not incorporated to maximize the absorption of gases into solution.

In the CO₂ scrubber of the present invention, the bubbles are produced by a froth generator at the top of a bubble column that is flowing in a downward direction. The ambient pressure on the bubble is continually increased as each bubble flows downward with the column of bubbles in the reaction chamber. As the ambient pressure increases, the diameter of the bubble is reduced, the tension in the bubble wall increases, and the vapor pressure inside the bubble increases, as described by LaPlace's Law. In the CO₂ scrubber of the invention, gases encapsulated inside the bubble, including gaseous CO2, are diffused through a common cell wall between adjacent bubbles with differential volumes and differential vapor pressures. The gases in the relative smaller bubble with relative higher vapor pressure are diffused through the common cell wall into a bubble with relative larger volume and with relative lower vapor pressure. Thereby, the CO₂ scrubber of the present invention incorporates increased pressure on the bubble, and inside the bubble, in order to maximize the absorption of gaseous CO₂ into a calcium hydroxide solution.

In the prior art AFA filter with nucleation (i.e. U.S. Pat. No. 6,872,240), the incoming air stream is “saturated with a fine mist generated with specially designed fogger nozzles” and the micro-droplets inside the bubbles are created by heterogeneous nucleation, the phase change from vapor to liquid being deposited onto condensation nuclei suspended in the air, inside the bubbles. In the AFA filter with nucleation, the liquid and vapor are cooled “on cold, preferably metal surfaces”, and the micro-droplets are formed by phase change from a super-saturated vapor to a liquid inside the bubbles, in the reaction chamber of the filter.

In the CO₂ scrubber of the present invention, the filtering solution is preferably cooled before the solution is pumped to the froth generators. As the mixed gases, solution droplets, and bubbles progress through a sequence of saturated mesh panels in the froth generator, micro-droplets formed by bursting bubbles and fragmenting droplets on the previous mesh panel are included inside bubbles being reformed on the next sequential mesh panel. The micro-droplets included inside the bubbles at the time of formation of the present invention are fragments of a larger liquid structure and not the result of phase change in physical state from a vapor to a liquid. In the present invention, the micro-droplets are included inside the bubbles while the bubbles are being formed, before leaving the froth generator.

In the AFA filter with nucleation (i.e. U.S. Pat. No. 6,872,240), the bubbles are formed when the gas is introduced below the surface of the filtering solution then cooled by mechanical means to induce heterogeneous nucleation of vapor onto condensation nuclei suspended in the air, inside the bubbles. The micro-droplets are formed inside the bubbles, after the bubbles have entered a nucleation chamber.

In the CO₂ scrubber of the present invention, the solution is cooled before entering the froth generator. A wide range of micro-droplet radii, including Kelvin-limit micro-droplets, are included inside the bubbles as a portion of the bubbles burst and are being formed. Discrete volumes of the relative hot, dry mixed gas stream, and relative cool micro-droplets and vapor are encapsulated inside the relatively cool bubbles. The relative hot gas vaporizes the Kelvin limit micro-droplets inside the bubbles. Although the least massive micro-droplets evaporate, water in the calcium hydroxide solution increases its volume by one-thousand six-hundred (1600) times when expanding into a vapor, thereby increasing the vapor pressure inside the bubbles. The sensible heat of the gas is converted to latent heat in order to expand the water molecules from a liquid into a gas, sensibly cooling the gas inside the bubbles. As the mass of relative cool liquid in the bubble wall that encapsulates the relative hot gas, cools the gas, the dew point inside the bubble is forced. The condensing vapor has an affinity for similar liquid surfaces, and the liquid that evaporated into a vapor initially, soon after the bubble was formed, condenses onto the micro-droplets originally encapsulated inside the bubbles during formation, thereby increasing the mass and diameter of the micro-droplets inside the bubbles over time.

In the AFA filter with nucleation (i.e. U.S. Pat. No. 6,872,240), the mixed gas stream is introduced below the surface of a filtering solution reservoir through a diffusing mechanism. The weight of the solution above the gas outlet portal must be moved by the gas pressure, resulting in relative high pressure drop across the diffusing mechanism. Large bubbles form in the solution reservoir, rise quickly through the froth column, and establish stable channels through the froth column that allows a portion of the stream of gases to bypasses liquid-to-gas contact with the solution. As the froth column increases in height, the pressure drop across the diffusing mechanism increases. In the AFA filter with nucleation therefore, the acceleration of gravity is not used to reduce the energy required to produce the column of bubbles.

In the CO₂ scrubber of the present invention, the bubbles are produced by a froth generator on top of the reaction chamber, above the bubble column. Solution is pumped to the froth generator in order to saturate an assembly of mesh panels. The stream of mixed gases, including gaseous CO₂, is forced through the saturated mesh panels to produce the column of bubbles. The bubbles are projected downward into the reaction chamber. In the CO₂ scrubber of the invention, the mesh panels are positioned perpendicular to the flow of mixed gases and to the acceleration-of-gravity, reducing the energy required to force the solution and gas stream through the mesh panels. In addition, the liquid froth matrix of the bubble column forms a fluid plug in the reaction chamber preventing gas from bypassing, or passing through, the column of bubbles. When the column of bubbles flows out of the reaction chamber, a relative low air pressure is formed at the top of the reaction chamber. The potential energy stored in the bubble column is partially converted to the kinetic energy of the bubble column flowing out of the reaction chamber, and partially converted to the kinetic energy of the mixed gas stream and the solution being drawn through the mesh panels as a column of bubbles. In the CO₂ scrubber of the present invention, the acceleration of gravity is thereby incorporated to reduce the energy required to produce the column of bubbles.

### PRIOR ART

### Econamine FG+ Amine-Type CO₂ Capture System with CO₂ Compression

In the prior art MonoEthanolAmine (MEA) scrubber, flue gas enters the contactor tower and rises through the descending amine solution. CO₂ and H₂S are removed by chemical reaction with the lean amine solution. Purified flue gas flows from the top of the tower. The rich amine solution is now carrying absorbed acid gases; CO₂ and H₂S. Lean amine solution returning from a heating stage to force release acid gases, and rich amine solution carrying CO₂ and H₂S flow through a heat exchanger, heating the rich amine. The acid-gas rich amine is then further heated in the regeneration-still column by heat supplied from the re-boiler. The steam rising through the still liberates H₂S and CO₂, regenerating the amine. Steam and acid gases separated from the rich amine are condensed and cooled. The condensed water is separated in the reflux accumulator and returned to the still. Hot, regenerated, lean amine is cooled in a solvent aerial cooler and circulated to the contactor tower, completing the cycle.

### Disadvantages:

High heat of reaction, high regeneration energy required; 1,500 to 3,500 Btu/lb CO₂ removed

Low pressure steam reduces power plant efficiency by 20 to 40%

Equipment degradation and corrosion; requires 10 ppm sulfur

High capital and operating costs

### BRIEF SUMMARY OF THE INVENTION

The present invention includes a method of separating gaseous CO₂ from a mixture of gases with high selectivity and sequestering the CO₂ from the atmosphere for geologic time, and describes a bubble-column reactor/scrubber for carbon-capture and sequestration. Gaseous CO₂ is captured and sequestered from a stream of mixed gases directly from the atmosphere, from post-combustion flue gas, and from processes that release gaseous CO₂ as a result of the process. A mesh panel assembly is saturated with a solution containing calcium ions (Ca++) and hydroxide ions (OH−). The mixed gas stream, including gaseous CO₂, is forced through the saturated mesh assembly to form an aqueous froth wherein the bubbles of the froth have their interior volumes filled with discrete volumes of mixed gases. At least some of the bubbles are caused to burst and reform, the bursting bubbles forming numerous micro-droplets having various radii, including Kelvin-limit radii, wherein each reforming bubble encapsulates a discrete volume of the gas stream, discrete number of solution micro-droplets, and a discrete volume of solution vapor. The size of the bubbles formed in the calcium hydroxide solution is limited by limiting the size of the openings in the mesh panels, and thereby forming a myriad of uniformly small bubbles, thereby maximizing the contact between CO₂ molecules, micro-droplets, and the inner and outer surfaces of the myriad of small bubbles.

The solution is preferably cooled before it flows through the saturated mesh panels. The cooled solution cools the gas encapsulated inside the bubbles, as the bubbles moves downwardly through the reaction chamber. When relative hot gas vaporizes the micro-droplets, sensible heat is converted to latent heat in order to separate the molecules of calcium hydroxide solution into a gas, thereby sensibly cooling the gas inside the bubbles. Although the micro-droplets that are vaporized are small, the water in the calcium hydroxide solution increases its volume sixteen-hundred times (1600) when vaporized, thereby increasing the vapor pressure inside the bubbles. The gas stream is carried downward by the bubble column through the reaction chamber in order to increase the reaction time between the gas stream and the myriad of small bubbles, and to increase the ambient pressure of the aqueous froth, thereby decreasing the volume of the bubbles and increasing solubility of the CO₂ molecules, respectively. The volumes of the bubbles are minimized to reduce the distance between the inner surfaces of the bubbles and the micro-droplets inside the bubbles, thereby reducing the mean-free-paths of CO₂ molecules inside the bubbles, in order to increase the rate at which CO₂ molecules collide with the surface of the calcium hydroxide solution, and thereby increases the rate of dissolution of CO₂. The CO₂ molecules dissolve into the solution, the reaction of CO₂ molecules with calcium ions (Ca++) and hydroxide ions (OH−) in solution form calcium carbonate (CaCO₃) molecules, and calcium carbonate precipitates out of the solution.

Thereby, the CO₂ scrubber of the present invention separates gaseous CO₂ from a mixture of gases with high selectivity, and sequesters the CO₂ from the atmosphere as calcium carbonate for geologic time.

### OBJECTS AND ADVANTAGES

It is an object and advantage of the invention to maximize the liquid-to-gas surface area of a calcium hydroxide solution between gaseous CO₂ in a mixture of gases and a calcium-hydroxide solution in order to facilitate the dissolution of CO₂ molecules from the stream of mixed gases, into the calcium hydroxide solution.

It is another object and advantage of the invention to maximize time-of-contact between gaseous CO₂ in a stream of mixed gases and the calcium hydroxide solution in order to facilitate the dissolution of CO₂ molecules from a stream of mixed gases, into the calcium hydroxide solution.

It is another object and advantage of the invention to cause at least some of the bubbles to burst and reform, the bursting bubbles forming numerous micro-droplets having various radii, wherein each reforming bubbles encapsulates a discrete volume of the mixed gas stream, a discrete number of the solution micro-droplets, and a discrete volume of solution vapor.

It is another object and advantage of the invention to decrease the temperature of the mixed gases, to facilitate the dissolution of CO₂ molecules from the stream of mixed gases, into the calcium hydroxide solution.

It is another object and advantage of the invention to increase the ambient pressure on the outside of the bubbles and the vapor pressure inside the bubbles, of calcium hydroxide solution in order to facilitate the dissolution of CO₂ molecules from the stream of mixed gases, into the calcium hydroxide solution.

It is another object and advantage of the invention to minimize the mean-free-paths of CO₂ molecules inside the bubbles by decreasing the volume of the bubbles to reduce the distance between the inner surfaces of each bubble and the micro-droplets inside each bubble, in order to maximize contact between the CO₂ molecules and the solution used to form the bubbles and micro-droplets.

It is another object and advantage of the invention to minimize mechanical structure while maximizing liquid to gas contact area, in order to maximize the removal of CO₂ from a mixture of gases while minimizing opportunities for calcium deposits to form.

### BRIEF DESCRIPTION OF THE DRAWINGS

FIG. 1 illustrates the front view of the carbon-capture scrubber of the present invention;

FIG. 2 illustrates the top view of the CO₂ scrubber;

FIG. 3 illustrates the front view of the froth generator for the CO₂ scrubber;

FIG. 4 illustrates the micro-droplet formation and encapsulation into bubbles;

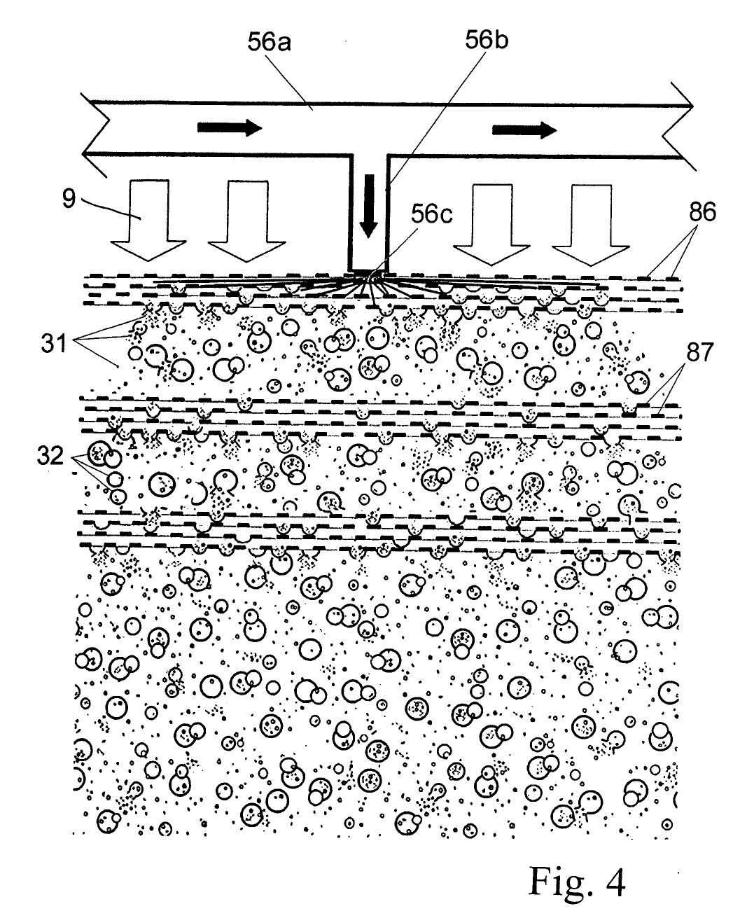

FIG. 5 illustrates a trimetric projection of the settling tank; and

FIG. 6 illustrates the top view of the CCS system with precipitant processing.

### DETAILED DESCRIPTION OF THE DRAWINGS

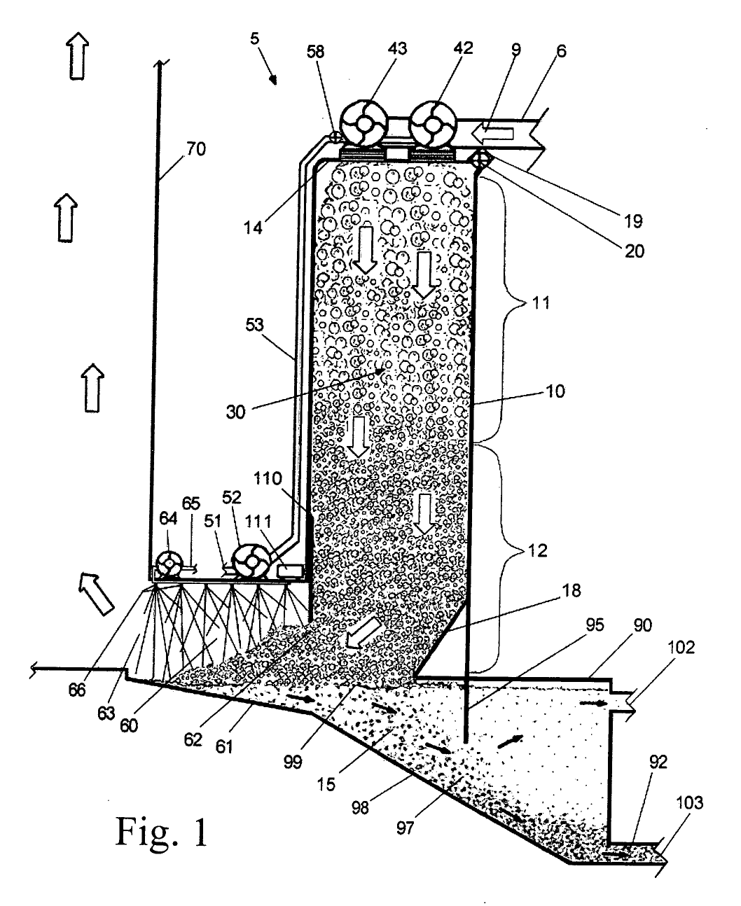

FIG. 1 shows an embodiment of the present invention that includes a bubble-column CO₂ reactor/scrubber 5 and a method of separating gaseous CO₂ from a mixture of gases. The CO₂ scrubber is designed to maximize the solubility of CO₂ into a calcium hydroxide solution by maximizing the liquid-to-gas interfacial area and time-of-exposure between the mixed gases and the calcium hydroxide solution, while increasing the ambient pressure on the bubbles and increasing the vapor pressure inside the bubbles. The CO₂ scrubber reduces temperature of the gases and the calcium hydroxide solution, while also reducing the volume of the bubbles, and the mean-free-paths of the CO₂ molecules. The CO₂ scrubber was also designed to minimize the opportunity for calcium deposits to form.

### Gas Inlet Duct

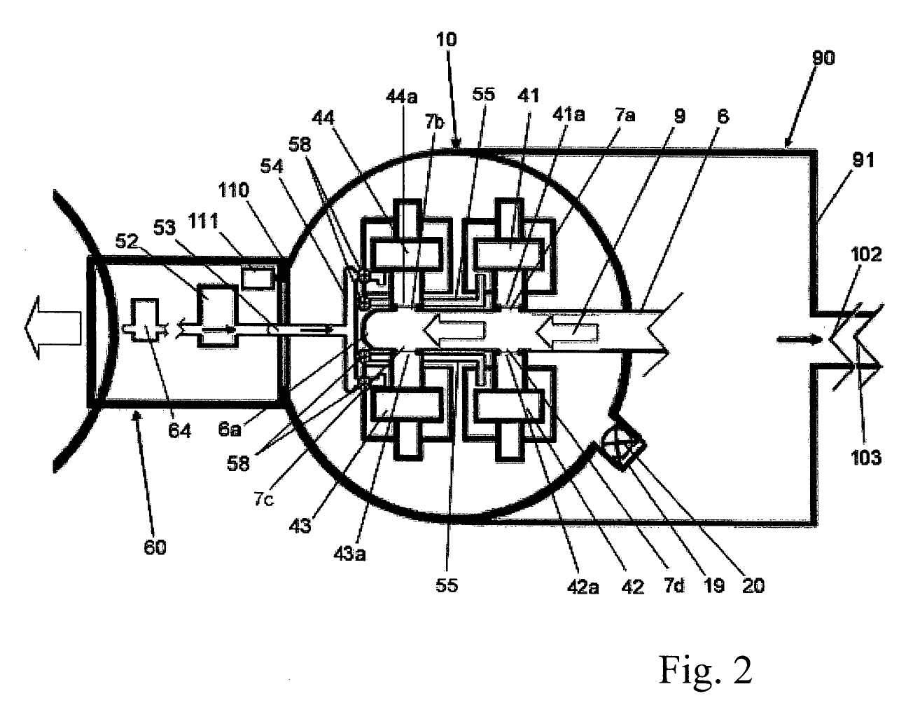

As shown in FIGS. 1 and 2, a gas inlet duct 6, with a plurality of gas outlet portals 7a, 7b, 7c and 7d located near a closed end 6a of the gas inlet duct 6 is located at the top of a reaction chamber 10. The plurality of gas outlet portals 7a-7d is connected to, and establishes fluid communication with, a plurality of gas inlet portals 41a, 42a, 43a, 44a of multiple froth generators 41-44. Gas stream 9 containing gaseous carbon dioxide flows through inlet duct 6 and into froth generators 41-44.

### Calcium Hydroxide Solution

Calcium hydroxide (solid) is dissolved in water to produce a preferred calcium hydroxide solution for a carbon-capture wet scrubber. The size range of the grains should be 5 microns to 10 microns, with 95% below 45 microns, to facilitate dissolution of the calcium hydroxide (solid) into solution. The calcium hydroxide solution consists of approximately 0.8 grams of calcium hydroxide per liter of water (0.8 gm/L) to provide a solution with an alkalinity of approximate pH 11.5, and a mild non-anionic surfactant to reduce the surface tension of the solution in order to form bubbles.

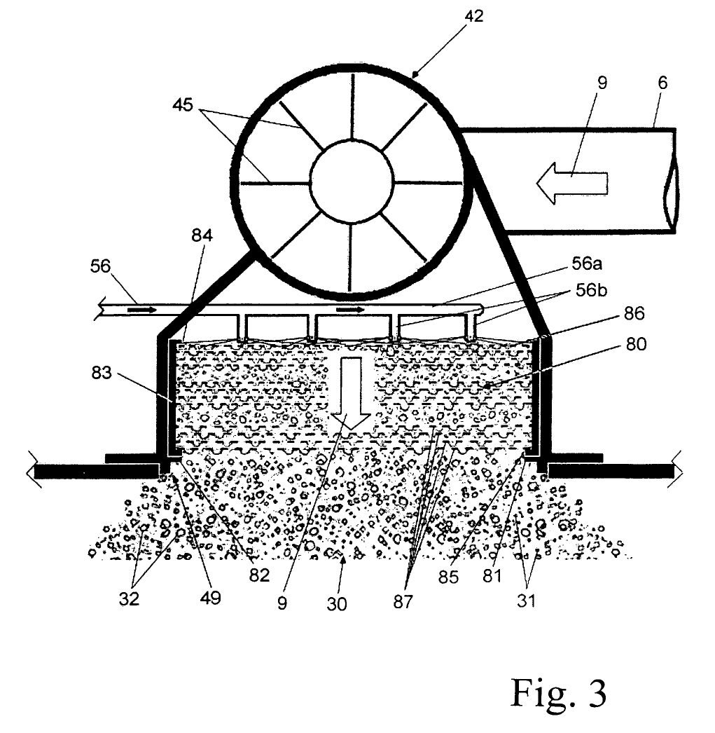

The calcium hydroxide solution distribution system (FIGS. 1 and 2) includes main solution supply pipe 51, a solution pump 52, a vertical solution supply pipe 53, a solution distribution manifold 54, and a plurality of solution distribution pipes 55. The calcium hydroxide solution pump 52 with an inlet portal and an outlet portal is located on top the dewatering chamber 60. The inlet portal of the pump 52 connects to, and establishes fluid communication with, the main solution supply pipe 51 from the heat exchanger (not shown in FIGS. 1-2). The vertical solution supply pipe 53 connects at a lower end to the outlet portal of the solution pump 52, and connects at an upper end to, and establishes fluid communication with, a solution distribution manifold 54 at the top of the reaction chamber 10. The solution distribution manifold 54 includes an inlet portal and a plurality of outlet portals. The solution distribution manifold 54 connects at the inlet portal to the outlet portal of the vertical solution distribution pipe 53. Each of the plurality of outlet portals 55 of the solution distribution manifold 54 connects to a spray-nozzle solution distribution pipe, such as pipe 56 (FIG. 3), in a froth-generator 42. Each froth generator 41-44 is similarly connected to manifold 54.

### CO₂ Scrubber

The CO₂ scrubber of FIG. 1 includes a vertical, elongated stainless steel reaction-chamber cylinder 10 with an upper reaction-chamber portion 11, a lower reaction-chamber portion 12, and a submarine portion 15. A settling tank 90 is attached to the submarine portion of the reaction chamber cylinder 10. The vertical reaction chamber cylinder 10, with an enclosed top 14, is connected to a vertical cylindrical exhaust stack 70, with an open top, by a horizontal, generally rectangular, dewatering chamber 60. A common, progressively downward-sloping bottom 61 of the dewatering chamber 60 and sloped bottom 98 of the submarine portion 15 of the reaction chamber 10 and the settling tank 90 forms a continuous compound slope in the general direction of a slurry channel 92 in the settling tank 90.

### Froth Generators

The froth generators 41-44 are located on top 14 of the reaction chamber 10. Froth generator 42 is shown in FIG. 3 and includes a blower 45, a solution inlet portal 56, and a solution distribution pipe 56a, a plurality of low-pressure (55 psi) spray nozzles 56b, a mesh panel assembly 80, and a froth outlet portal 49 with mesh panel assembly support rails 81,82.

The high-volume blower 45 includes components not shown, including an electric motor, a turbine, and volute with a gas inlet portal and a gas outlet portal. The electric motor imparts rotational motion to the turbine through mechanical means. The turbine is located inside the volute, and includes blades, paddles, vanes, or other mechanical means to convert the rotational motion of the electric motor to increase the pressure of the gas stream 9. The gas inlet portal in the volute is connected to, and establishes fluid communication with, one of the plurality of gas outlet portals in the gas inlet duct 6. The gas outlet portal of the volute establishes fluid communication with, a gas inlet portal in the mesh panel assembly 80.

The solution inlet portal 56 is connected to, and establishes fluid communication with, the solution distribution pipe for the plurality of low-pressure (55 psi) spray nozzles 56b. Each spray nozzle includes a solution inlet portal and a plurality of solution outlet portals 56c. The solution inlet portals are connected to, and establish fluid communication with, the solution distribution pipe 56. The solution outlet portals 56c are located near the closed end of the spray nozzle 56b, and form a radial pattern perpendicular to, and concentric with, the linear axis of the cylindrical spray nozzle 56b. The solution outlet portals 56c of the spray nozzles 56b are positioned proximal to the first mesh panel 86 at the top of the mesh panel assembly 80. The circular area produced by the radial pattern of the solution jets from the spray nozzles is perpendicular to the mixed gas stream 9, collateral with the mesh panels 87, and concentric with, the linear axis of the cylindrical spray nozzles 56b.

The removable mesh panel assembly 80 is on support rails 81,82 located inside the froth outlet portal 49 of the froth generator 42, and includes a frame 83, an inlet portal 84, an outlet portal 85, a plurality of spacers (not shown), and a plurality of wire-mesh panels 87. A further description of the froth generators and mesh panels is contained in parent application Ser. No. 11/729,253, incorporated by reference. The mesh panels include a plurality of mesh openings, between 2 millimeters and 25 millimeters, which are distributed over a bubble-producing area of the mesh panel. The mesh panels 87 are located in the rectangular frame 83 and positioned with the area of the mesh openings perpendicular to the flow of mixed gasses 9. Each successive mesh panel 87 is collateral to, and below the previous mesh panel The plurality of mesh panels is assembled in a frame 83 that is removable from the froth generator. The mesh panels 87 are separated by spacers (not shown) ranging from 5 millimeters to 0.5 meters, depending on the scale of the application and the flow rate of the gas stream 9. The outlet portal of the mesh panel assembly 80 is inside of, and establishes fluid communication with, the froth outlet portal 49 of the froth generator. The froth outlet portal 49 of the froth generator is connected to, and establishes fluid communication with, the upper portion 11 of reaction chamber 10.

### Reaction Chamber

The reaction chamber 10 is a vertical cylindrical chamber, with a closed top 14, supporting the array of froth generators 41-44, an upper portion 11, a lower portion 12 connected to the inlet portal 62 of the dewatering chamber 60, and a submarine portion 15 connected to the inlet portal 97 of the settling tank 90. The reaction chamber 10 includes a plurality of froth inlet portals beneath the froth generators 41-44, an air vent 19 with a flow-control valve 20, and an angled lower wall portion 18.

An adjustable outlet panel 110 is connected to and driven upwardly or downwardly by electric motor 111. Adjustable panel 110 controls the size of the opening 62 into the dewatering chamber 60. Panel 110 may totally close opening 62, for example, at start-up.

The plurality of inlet portals establishes fluid communication between the reaction chamber 10 and the plurality of outlet portals of the multiple froth generators 41-44. The air vent 19 is located at the top of the reaction chamber and establishes fluid communication between the reaction chamber 10 and the atmosphere when the flow control valve 20 in the air vent 19 is open. The adjustable portal 62 is located at the bottom of the reaction chamber 10, and establishes fluid communication between the reaction chamber 10 and the dewatering chamber 60 when the outlet panel 110 is adjustably opened. The electric motor 111 is connected to a gearing mechanism (not shown) that is connected to, and converts the rotational motion of the electric motor 111 to the vertical translational motion of the adjustable outlet panel 110.

The surface 99 of the calcium hydroxide solution constitutes the bottom of the lower portion of the reaction chamber 12 and the top boundary of the submarine portion 15 of the reaction chamber 10. The wall of reaction chamber cylinder 10 forms a partition 95 between relative energetic hydrodynamic currents of the submarine portion 15 of the reaction chamber 10, and relative calm hydrodynamic currents of the settling tank 90.

The bottom 98 of the in the submarine portion 15 of the reaction chamber 10 extends from the bottom of froth inlet portal 62 of the dewatering chamber 60 to the beginning of the slurry channel 92 in the settling tank 90, with slope of between 30°-to-45° (30° illustrated) downward in the direction of the settling tank 90, The plane of the bottom 98 slices through the bottom portion of the reaction-chamber cylinder wall between the dewatering chamber 60 and the intersection of the reaction-chamber cylinder wall with the vertical parallel walls 93, 94 of the settling tank 90. The plane of the bottom 98 of the submarine portion 15 of the reaction chamber 10 extends below the cylinder wall 95, thereby creating an opening 97 and establishing fluid communication between the submarine portion 15 of the reaction chamber 10 and the settling tank 90. The vertical central axis of the opening 97 between the in the submarine portion 15 of the reaction chamber 10 and the settling tank 90 being located 180° from the vertical central axis of the main solution outlet portal 102 of the settling tank 90 and 180° from the vertical central axis of the froth outlet portal 62 of the reaction chamber 10.

### Dewatering Chamber

The dewatering chamber 60 is a generally rectangular chamber, located between the lower section 12 of the reaction chamber 10 and exhaust stack 70. Chamber 60 has a sloping bottom 61, a low pressure (125 psi) dewatering solution pump 64, a spray-nozzle distribution pipe 65, a plurality of low-pressure (125 psi) spray nozzles 66. The rectangular froth inlet portal 62 has a longer vertical axis than the vertical axis of the relatively square gas outlet portal 63. The top of the dewatering chamber 60 is horizontal. A 10° to 20° downward (negative) slope is formed by the bottom 61 of the dewatering chamber.

The dewatering pump 64 is located on top of the dewatering chamber 60. The pump 64 is connected to a main solution supply pipe 51. Pump 64 is connected to the plurality of dewatering spray nozzles 66, inside the dewatering chamber 60. Each of the plurality of spray nozzles 66 has a spray outlet portal in the end of the nozzle that establishes fluid communication with the atmosphere in the dewatering chamber 60.

### Exhaust Stack

The vertical exhaust stack 70 is located at the end of the horizontal dewatering chamber 60, and includes an inlet portal, an outlet portal, heat exchanger coils and a vane-type mist eliminator (not shown). Exhaust stack 70 is in fluid communication with dewatering chamber 60 through the inlet portal 63. The top of exhaust stack 70 is open to the atmosphere through the outlet portal. Heat exchanger coils (not shown), from a heat exchanger (not shown) in the main solution supply pipe, are mounted to the inside upper walls of the exhaust stack. A vane-type mist eliminator (not shown), with sharply-angled, closely-echeloned stainless steel vanes, is mounted with its circular area concentric with, and perpendicular to, the linear axis of the exhaust stack, and thereby perpendicular to the gas stream 9.

### Settling Tank

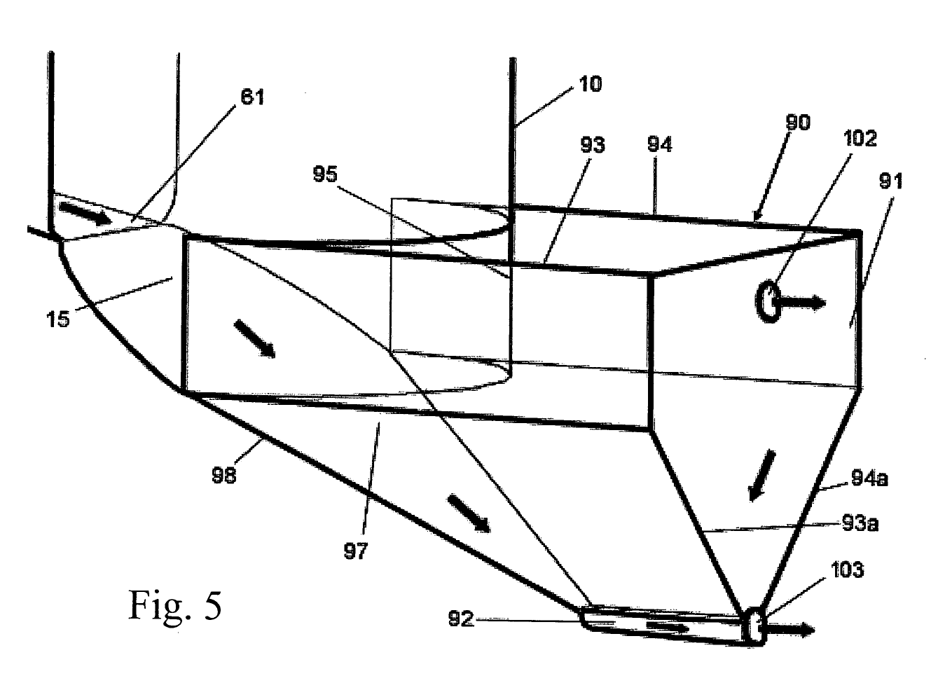

As shown in FIG. 5, parallel, vertical, flat walls 93,94 of the settling tank 90 attach to the reaction chamber cylinder 180° from each other and 90° from the vertical central axis of the outlet portal 97 between the submarine portion 15 of the reaction chamber 10 and the settling tank 90. Angled lower portions 93a,94a of the two parallel walls 93,94 in the settling tank slopes at between 30° and 45° (45° illustrated) toward the direction of the slurry channel 92, respectively. A coarse-precipitant slurry collection channel 92 is formed in the bottom of the settling tank 90 collateral to the bottom of the angled parallel walls 93a, 94a. A slurry outlet portal 103 is located on the vertical central linear axis, near the bottom of the vertical flat end-wall 91 of the settling tank 90. The slurry outlet portal 103 is connected to, and establishes fluid communication with, the slurry-outlet pipe (not shown). The main solution flow outlet portal 102 is located on the central vertical axis, near the top, of the vertical flat end wall 91 of the settling tank 90. The top of the settling tank 90 is opened to the atmosphere.

### Operation

The present invention includes a CO₂ scrubber, and a method of separating gaseous CO₂ from a mixture of gases as calcium carbonate. The CO₂ scrubber incorporates a calcium hydroxide solution to react with dissolved CO₂ with high selectivity, and precipitate calcium carbonate out of solution, and is designed to maximize the absorption of gaseous CO₂ into solution while minimizing the opportunity for calcium deposits to form.

The plurality of mesh openings, in the plurality of mesh panels 87, in the mesh panel assembly 80 (FIG. 3) is saturated with calcium hydroxide solution containing calcium ions (Ca++) and hydroxide ions (OH−). The mixed gas stream 9, including gaseous CO₂, is forced through the saturated mesh assembly 80 to form an aqueous froth wherein the calcium hydroxide bubbles of the froth have their interior volumes filled with discrete volumes of the mixed gases. At least some of the bubbles are caused to burst and reform, the bursting bubbles forming numerous micro-droplets 31 having various radii, including Kelvin limit micro-droplets (FIG. 3), wherein each reforming bubble encapsulates a discrete volume of the gas stream 9, discrete number of solution micro-droplets 31, and a discrete volume of solution vapor. The size of the bubbles formed is limited by limiting the size of the openings in the mesh panels 87, and thereby forming a myriad of uniformly small bubbles 32, thereby maximizing the contact between CO₂ molecules, micro-droplets 31, and the inner and outer surfaces of the myriad of small bubbles 32.

The Kelvin limit for micro-droplets is the limit of the micro-droplet radius, at ambient conditions, at which the micro-droplet begins irreversible evaporation caused by vapor loss due to the extreme curvature of the surface of the micro-droplet. Calcium hydroxide micro-droplets 31 with a wide distribution of micro-droplet radii, including Kelvin-limit micro-droplets, are included in the reforming bubbles 32 (see FIG. 3).

Sensible heat is converted to latent heat to separate the molecules of calcium hydroxide solution into a gas when the Kelvin limit micro-droplets are vaporized, thereby cooling the gas inside the bubbles. Water in the calcium hydroxide solution increases its volume one-thousand six-hundred times (1600) when vaporized, thereby increasing the vapor pressure inside the bubble. The gas stream 9 is carried downward by the bubble column 30 through the reaction chamber 10 in order to increase the reaction time between the gas stream 9 and the myriad of small bubbles 32, and to increase the ambient pressure on the bubbles, thereby decreasing the size of the bubbles and increasing solubility of the CO₂ molecules. The mean free path of CO₂ molecules inside the bubbles is minimized by decreasing the volume of the bubbles in order to reduce the distance between the inner surfaces of the bubble and the micro-droplets 31 inside the bubble 32, thereby increasing the rate at which CO₂ molecules collide with the surface of the calcium hydroxide solution. The increased rate of collisions between the CO₂ molecules and the solution increases the rate of dissolution of CO₂. Thereby, the CO₂ scrubber of the present invention maximizes the dissolution of gaseous CO₂ into the calcium hydroxide solution. CO₂ molecules carried in the solution, form calcium carbonate (CaCO3) molecules by the reaction of CO₂ molecules with calcium ions (Ca++) and hydroxide ions (OH−) in solution, and calcium carbonate precipitates out of the solution.

### Gas Inlet Duct

The gas inlet duct 6 transports the stream of mixed gases 9, including gaseous CO₂, through the plurality of gas outlet portals 7a-7d located near a closed end 6a of the gas inlet duct 6 to the plurality of gas inlet portals 41a, 42a, 43a, 44a of the multiple froth generators 41-44.

### Calcium Hydroxide Solution

Calcium hydroxide (solid) is dissolved in water to produce a preferred calcium hydroxide solution for a carbon-capture wet scrubber. The size range of the grains are between 5 microns and 100 microns, with 95% below 45 microns, to facilitate dissolution of the calcium hydroxide (solid) into solution. The calcium hydroxide is dissolved in water at a concentration of 0.8 grams/Liter increasing the alkalinity of the calcium hydroxide solution to approximately 11.5 with mild non-anionic surfactant to reduce the surface tension of the solution in order to form bubbles of calcium hydroxide. The concentration of the surfactant determines the life of the bubbles. The surfactant concentration is adjusted so that most of the bubbles last long enough to encapsulate the mixed gases 9 from the froth generators 41-44 to the dewatering chamber 60, but are dewatered by the impact of projectile droplets from the spray nozzles 66 in the dewatering chamber 60.

The calcium hydroxide solution is cooled to a relative low temperature at least 20° C. below the relative high temperature of the mixed gas stream 9, and pumped from the calcium hydroxide solution pump 52 through the vertical solution supply pipe 53 to the solution distribution manifold 54 on top 14 of the reaction chamber 10. The solution distribution manifold 54 distributes the calcium hydroxide solution to the plurality of froth generators 41-44 on top 14 of the reaction chamber 10. The calcium hydroxide solution is distributed from the solution distribution manifold 54 to the solution distribution pipes 55. The flow of solution to the froth generators 41-44 is regulated by flow control valves 58 in the solution distribution pipes 55. The flow of solution to the froth generators 41-44 can be cutoff to remove and replace the mesh panel assemblies 80 during periodic routine maintenance.

### CO₂ Scrubber

The CO₂ scrubber of the invention is designed to maximize the dissolution of CO₂ into the calcium hydroxide solution, while minimizing mechanical structure that would provide the opportunity for calcium deposits to form. The calcium hydroxide solution is cooled before the CO₂ scrubber, to increase the solubility of CO₂. The CO₂ scrubber encapsulates the stream of mixed gases 9, including gaseous CO₂, with calcium-hydroxide solution micro-droplets 31 and vapor inside the bubbles 32 of an aqueous froth of calcium hydroxide solution. The relative hot gas inside the bubble 32 vaporizes the smallest micro-droplets, converting sensible heat to latent heat, thereby cooling the gas inside the bubble 32. The micro-droplets 31 that are vaporized expand their volumes to sixteen hundred times their liquid volumes, thereby increasing the vapor pressure inside the bubble 32. The bubble column 30 flows downward through the reaction chamber 10, increasing the ambient pressure on the bubbles, reducing the bubble volume, and increasing the vapor pressure inside the bubbles 32. Gases, including gaseous CO₂ that are included inside the bubbles, are diffused through a common cell wall by differential pressures between adjacent bubbles of differential volumes. As the volume of the bubbles decreases, the mean-free-paths of the CO₂ molecules decrease, thereby increasing the rate at which gaseous CO₂ is dissolved into the calcium hydroxide solution. Thereby, the CO₂ scrubber maximizes the dissolution of gaseous CO₂ into the calcium hydroxide solution. Dissolved CO₂ reacts with calcium ions and hydroxide ions in solution, and precipitates calcium carbonate out of solution.

The column of bubbles 30 forms an aqueous-froth matrix of Plateau borders; the intersection of intercellular walls between adjacent bubbles of the aqueous froth, and Plateau border junctions; the intersection of three or more Plateau borders, which constitute an intricate interconnected fluid structure that flows with the bubble column 30. The aqueous froth matrix exponentially increases the liquid-to-gas interfacial area of the calcium hydroxide solution. The liquid froth matrix constantly replenishes itself as the bubble column 30 is being formed and carries the precipitants through the reaction chamber 10 to the calcium-hydroxide solution tanks at the bottom of the CO₂ scrubber. The surface of the calcium hydroxide solution 99, at the bottom of the lower reaction chamber 12 constitutes the top of the submarine portion 15 of the reaction chamber 10, and in the bottom of the dewatering chamber 60, forms the top of the submarine portion of the dewatering chamber 60. Precipitants in suspension in the froth matrix of the bubble column 30 are deposited directly into the calcium hydroxide solution at the bottom of the reaction chamber 10 and dewatering chamber 60 to minimize opportunity for calcium deposits to form. Hydrodynamic currents, and the slopes of the of the bottoms 61,98 in the dewatering chamber 60 and the submarine portion 15 of the reaction chamber 10 transport the precipitants to the settling tank 90. Thereby, the CO₂ scrubber of the invention is designed to minimize the opportunity for formation of calcium deposits.

### Froth Generators

The stream of mixed gases 9 containing gaseous CO₂ flows from the gas inlet duct 6 into the plurality of froth generators 41-44 located at the top 14 of the vertical reaction chamber 10. The mixed gas stream 9 enters each of the froth generators 41-44 through the inlet portal of the volute. The blades of the turbine and the shape of volute increase the pressure of the gas stream in order to force the mixed gases and calcium hydroxide solution through the mesh panel assembly 80 in order to force the mixed gas stream 9 and calcium hydroxide solution through the mesh panel assembly 80.

The calcium hydroxide solution is distributed to the spray nozzles 56b through the solution inlet portals in the spray nozzle distribution pipes 55 of the froth generators 41-44. The spray nozzle distribution pipes 55 supply solution to the plurality of low-pressure spray nozzles 56b. The low-pressure (55 psi) spray nozzles 56b distribute the solution through the outlet portals 56c in the spray nozzles, in a radial pattern around the spray nozzle, in order to saturate the mesh panels 87 with the calcium hydroxide solution.

The mesh panel assembly 80 in each of the froth generators 41-44 is saturated with calcium hydroxide solution containing calcium ions (Ca++) and hydroxide ions (OH−) that react with the gaseous CO₂. The mixed gas stream 9, having gaseous CO₂, is forced at relative high pressure from the outlet portal of the volute through the inlet portal 84 of the mesh panel assembly 80. The mixed gases 9 are forced through the mesh openings in the saturated mesh panel assemblies 80 to form a column of bubbles 30.

The size of the bubbles formed from forcing the stream of mixed gases 9 and calcium hydroxide solution through the mesh panels 87 is proportional to the size of the openings in the mesh panels 87. The size of the bubbles formed is limited by limiting the size of the openings in the mesh panels 87, forming a myriad of uniformly small bubbles 32, thereby maximizing the contact between the CO₂ molecules, solution micro-droplets 31, and the inner and outer surfaces of bubbles. The bubbles 32 are forced out of the mesh panels 87 through the outlet portal 85 in the mesh panel assembly 80, and subsequently out the outlet portal 49 of the froth generator, and through the froth inlet portal in the top 14 of the reaction chamber 10.

The acceleration of gravity reduces the energy required to force the mixed gas stream 9 and calcium hydroxide solution through the mesh panel assemblies 80. Bubbles are produced as the gas stream 9 forces the solution through the saturated mesh panels 87 of the froth generators 41-44. The bubbles are formed, burst, and are reformed as mixed gases, calcium hydroxide solution droplets 31, bubbles 32, micro-droplets, and vapor pass through the mesh openings and progress sequentially through the mesh panels 87 in the mesh panel assembly 80. The mixed gases, including gaseous CO₂, and the calcium hydroxide solution micro-droplets 31 and vapor are included inside the reformed bubbles 32. The micro-droplets suspended in the gas inside bubbles are formed by liquid fragments from bursting bubble walls and droplets fragmented into micro-droplets by the mixed gas stream 9, and are included in the secondary bubbles reformed as the solution and mixed gases are forced through the subsequent mesh panels 87. The bubbles 32 are projected downward into the reaction chamber 10.

### Reaction Chamber

The reaction chamber 10 is designed to maximize the solubility of CO₂ into the calcium hydroxide solution and minimize the opportunity for calcium deposits to form. The solubility of CO₂ is proportional to pressure, and inversely proportional to temperature.

The mixed gases are encapsulated inside the bubbles of calcium hydroxide solution in order to increase the time-of-contact between the mixed gases 9 and the myriad of bubbles 32 of calcium hydroxide solution. The relatively hot, dry mixed gas stream 9 vaporizes Kelvin-limit micro-droplets inside the bubbles, increasing the vapor pressure inside the bubbles, and cooling the gas inside the bubble. The cooled calcium hydroxide solution that makes up the liquid froth matrix cools the mixed gases in the bubbles. As the gas inside the bubbles cool, liquid that had initially vaporized condenses back to liquid. The condensing vapor has an affinity for similar liquid surfaces, and condenses onto the micro-droplets suspended in the air inside the bubbles, and onto the walls of the bubbles.

As the reaction chamber 10 is being filled with bubbles 32, the flow control valve 20 in the air vent 19 is opened, and air in the reaction chamber 10 is displaced through the air vent into the atmosphere. When the reaction chamber 10 is filled with bubbles to the predetermined volume, the flow control valve 20 in the air vent 19 is closed, cutting off fluid communication between the reaction chamber 10 and the atmosphere through the air vent 19.

The column of calcium hydroxide bubbles 30, as shown in FIG. 1, forms a calcium hydroxide froth matrix that fills the diameter of the reaction chamber 10 to a predetermined height, and forms a fluid plug in the reaction chamber 10, preventing gas from bypassing, or passing through, the column of bubbles 30. The froth outlet portal 62 is opened by raising the adjustable outlet panel 110 with the electric motor 111 and gearing mechanism (not shown). The column of bubbles 30 begins to flow from the reaction chamber 10 into the dewatering chamber 60 from the acceleration-of-gravity and the relative high air pressure from the blowers 45 in the froth generators 41-44. The angled lower wall portion 18 in the reaction chamber 10 deflects the flow of the column of bubbles 30 on the opposite side of the reaction chamber 10 from the froth outlet portal 62, in the direction of the froth outlet portal 62.

During normal operation, the flow control valve 20 in the air vent 19 is closed, preventing the air from the atmosphere from entering the reaction chamber 10 through the air vent 19. The relative low air pressure at the top of the reaction chamber 10 and the volume of froth in the reaction chamber 10 are maintained at predetermined levels to maintain a consistent vertical pressure gradient in the reaction chamber 10 by balancing the flow of bubbles from the froth generators 41-44 with the flow of bubbles from the froth outlet portal 62 at the bottom of the reaction chamber 10.

The solubility of CO₂ is proportional to pressure. The flow of the bubble column 30 in the reaction chamber 10 is downward from the froth generators 41-44 at the top of the reaction chamber 10, to the dewatering chamber 60 at the bottom of the reaction chamber 10 in order to increase the ambient pressure on the bubble by the weight of the bubble column 30 above. The bubbles become smaller as they move downwardly in reaction chamber 10, as shown in FIG. 1. The increase in ambient pressure reduces the volume inside the bubble available to the mixed gases and increases the vapor pressure inside the bubble, in order to increase the solubility of gaseous CO₂ into the calcium hydroxide solution. As the volume inside the bubble available to the mixed gases is reduced, the distance the CO₂ molecules have to travel between collisions with the surface of the solution is proportionally reduced, the mean-free-paths the molecules have to travel between collisions and the surface of the solution decreases, increasing the concentration of CO₂ in solution at a faster rate.

The vapor pressure inside the bubble is proportional to the tension in the bubble wall, and inversely proportional to the radius of the bubble (LaPlace's Law); therefore the smaller the bubble, the higher the vapor pressure inside the bubble. The mixed gases that are encapsulated inside the bubbles of the froth are diffused through common cell walls by differential pressures between adjacent bubbles of differential volumes. Small bubbles, with relative high vapor pressure diffuse their volume of mixed gases, including gaseous CO₂ through the common cell wall into larger bubbles with lower vapor pressure.

Dissolved CO₂ molecules react with calcium ions and hydroxide ions in solution to form calcium carbonate molecules and precipitate calcium carbonate out of solution.

The liquid surface 99 of the calcium hydroxide solution facilitates the flow of the column of bubbles 30 from the reaction chamber 10 into the dewatering chamber 60 and does not provide the opportunity for calcium deposits to form. As the bubble column 30 flows out of the reaction chamber 10, into the dewatering chamber 60 by the weight of the bubble column 30, relative low air pressure is created at the top of the reaction chamber 10.

The relative low air pressure at the top of the reaction chamber 10 reduces the energy required by the blowers 45 to force the mixed gas stream 9 and calcium hydroxide solution through the mesh panel assemblies 80. The relative low air pressure at the top of the reaction chamber 10 and the volume of froth in the reaction chamber 10 are controlled by balancing the flow of bubbles from the froth generators 41-44 with the flow of bubbles from the froth outlet portal 62 at the bottom of the reaction chamber 10.

The submarine portion 15 of the reaction chamber 10 is located below the reaction chamber 10 to minimize opportunity for calcium deposits to form. The 30° angled bottom 98 extends below reaction chamber 10 cylinder causing precipitants to flow downwardly into the settling tank 90.

The full flow of solution and hydrodynamic energy from the drainage of the froth matrix in the reaction chamber, the spray nozzles 66 and the dewatered bubbles and in the dewatering chamber 60 passes through the submarine portion 15 of the reaction chamber 10. The volume of calcium hydroxide solution the submarine portion 15 of the reaction chamber is larger than submarine portion of the dewatering chamber 60, and smaller than the volume of solution in the settling tank 90, progressively reducing the energy available to the solution to keep massive precipitants in suspension. The hydrodynamic energy-state of the calcium hydroxide solution through the submarine portion 15 of the reaction chamber 10 keeps all but the most massive precipitants in suspension. The majority of the precipitants are carried in suspension into the settling tank 90. The most massive precipitants that settle out of solution in the reaction chamber 10 assemble into very-loosely consolidated masses on the sloping bottom 98 and, due to localized instability, slump along the angled bottom 98 into the bottom of settling tank 90.

### Dewatering Chamber

As the column of bubbles flow into the dewatering chamber 60, the bubbles are dewatered by impact of projectile spray droplets with the walls of the bubbles from the plurality of spray nozzles 66 located at the top of the dewatering chamber 60. The gas released from the bubbles flows from the dewatering chamber 60 into the exhaust stack 70. Precipitants included in the bubbles are deposited into the calcium hydroxide solution at the bottom of the dewatering chamber 60 to minimize opportunity for calcium deposits to form. The surface of the solution in the dewatering chamber forms the common bottom with reaction chamber 10 that facilitates the flow of bubbles from the reaction chamber 10 into the dewatering chamber 60.

The main flow of solution through the CO₂ scrubber is from froth generators 41-44 at the top of the reaction chamber 10 and spray nozzles 66 in dewatering chamber 60, into the solution in the bottom of the dewatering chamber 60 and into the submarine portion 15 of the reaction chamber 10. The hydrodynamic energy from the flow of solution from the dewatered bubbles and the spray nozzles 66 at the top of the dewatering chamber 60 is concentrated in the relative small volume of calcium hydroxide solution in the submarine portion of the dewatering chamber 60. The relative high energy transports the massive precipitants, that would settle out of solution under less energetic hydrodynamic conditions, into the submarine portion 15 of the reaction chamber 10. The hydrodynamic energy of the flow of solution through the CO₂ scrubber from the production of the aqueous froth, the drainage of the aqueous froth matrix in the reaction chamber 10, the 10°-to-20° angle (10° illustrated) of the sloping bottom 61 of the submarine portion of the dewatering chamber 60, the 30°-to-45° angle (30° illustrated) of the bottom 98 of the submarine portion 15 of the reaction chamber 10 and settling tank 90, transports and deposits precipitants from the submarine portion of the dewatering chamber 60 through the submarine portion 15 of the reaction chamber 10 and into the settling tank 90.

### Settling Tank

The reduced hydrodynamic energy of the settling tank 90 separates the massive calcium carbonate precipitants from the fine precipitants in suspension. Massive precipitants settle out of suspension and are deposited into the slurry channel 92 in the bottom of the settling tank 90 by alluvial processes. Less massive precipitants remain in suspension. Precipitants that settle out of solution in the settling tank 90 not directly above the slurry channel 92 slide or slump along the 45° angled sides of the lower portions 93a, 94a of the parallel walls 93, 94 of the settling tank 90. Hydrostatic pressure of the settling tank 90 pushes coarse precipitant slurry through the coarse precipitant slurry portal 103. The less-massive precipitants remain in suspension flow from settling tank 90 through the main solution-flow portal 102.

### Exhaust Stack

The gas released from bursting bubbles in the dewatering chamber 60 enters the exhaust stack 70. In the relative increased diameter of the exhaust stack 70, energy available to the airflow to carry micro-droplets is reduced. Massive micro-droplets entrained in the stream of gases 9 are removed by gravity separation. Less massive micro-droplets are removed from the gas stream 9 by inertial impaction on sharply-angled, closely-echeloned vanes of a mist eliminator located in the top of the exhaust stack 70. The mixed-gas stream that has been scrubbed of at least a portion of the gaseous CO₂ is released to atmosphere.

### Theory of Operation

The present invention for CCS includes a CO₂ scrubber and a method of separating gaseous CO₂ from a mixture of gases. The CO₂ scrubber is designed to maximize the absorption of gaseous CO₂ into solution. The CO₂ scrubber incorporates a calcium hydroxide solution to react with dissolved CO₂ with high selectivity, and precipitate calcium carbonate out of solution.

The solution is cooled and the ambient pressure on the bubbles and the vapor pressure inside the bubbles is increased, in order to increase the solubility of CO₂. The liquid-to-gas ratio and time-of-exposure between the gaseous CO₂ and the calcium hydroxide solution are maximized by encapsulating the gas stream and micro-droplets of calcium hydroxide solution inside a myriad of universally small calcium hydroxide bubbles. The column of bubbles flows downward into the reaction chamber, incorporating the acceleration-of-gravity to reduce the energy required to force the gas stream through saturated mesh panels in order to produce the column of bubbles. The ambient pressure on the bubbles increases as the bubbles flow downward into the reaction chamber, increasing the tension in the bubble walls and subsequently, the vapor pressure inside the bubble. Gases, including gaseous CO₂ that are included inside the bubbles, are diffused through a common cell wall by differential pressures between adjacent bubbles of differential volumes. The gas diffuses from the relative smaller bubble with relative high vapor pressure into the relative larger bubble with relative low vapor pressure, forcing dissolution of CO₂ into solution.

Reducing the volume of the bubbles, and increasing the diameter of calcium hydroxide micro-micro-droplets suspended in the air inside the bubbles by condensation, maximizes liquid-to-gas contact and reduces the mean-free-paths the CO₂ molecules have to travel before colliding with the surface of the calcium hydroxide solution, thereby maximizing the solubility and the rate of absorption of CO₂, respectively. The dissolved CO₂ is sequestered from the atmosphere for geologic time with the precipitation of calcium carbonate. The calcium carbonate precipitants are processed and sold for mineral filler, acidic soil neutralization, slope stabilization, flow-able fill, and as admix for Portland cement. After water, concrete is the most-used commodity by humans. In a highly purified form, Precipitated Calcium Carbonates (PCCs) are used in industrial processes to manufacture paper, plastics, food, and medicine. The sale of recovered CO₂ as calcium carbonate precipitants returns at least a portion of the costs of CCS.

A calcium oxide plant is located at a geologically favorable site with access to a limestone deposit, a natural gas deposit, natural gas distribution pipeline, and/or conditions favorable to the geologic sequestration of CO₂ released during the production of calcium oxide. Limestone is heated in a lime kiln, driving off CO₂ to form calcium oxide. The CO₂ gas that is released during the production of calcium oxide is geologically sequestered for enhanced oil field recovery (EOR), enhanced coal-seam methane recovery (ECMR), in situ carbonation, in saline aquifers, un-minable coal seams, or below cap-rock formations. The calcium oxide that has been environmentally responsibly produced is transported from the site of production, to the site of CCS. For removal of CO₂ directly from the atmosphere, the CCS operation can be located at the same geologically favorable location as the calcium oxide plant.

At the site of CCS, the calcium oxide is slaked with water to produce calcium hydroxide (solid). The calcium hydroxide is dissolved in water to produce a calcium hydroxide solution.

Considerable heat is released when calcium hydroxide and sodium hydroxide solutions are prepared.

In the case of calcium hydroxide the reaction is:

CaO+H₂O→Ca(OH)_{2(aq)}+heat

The heat released in case of calcium hydroxide is determined by the change in enthalpy to be 65.3 kj/mol.
In the case of sodium hydroxide the reaction is:

NaOH+H₂O→NaOH_{aq}+heat

The heat released in the case of sodium hydroxide is determined by the change in enthalpy to be 44.5 kJ/mol.

The solubility in water at 20 C of calcium hydroxide and sodium hydroxide respectively is 0.165 gm/100 ml and 111 gm/100 ml. The comparatively lower solubility of calcium hydroxide does not prevent obtaining pH (>10) required for rapid carbon dioxide absorption.

Special care must be taken when using calcium hydroxide for CO₂ capture due to kinetic concerns. As discussed by Brinkman et. al. [1] the reaction rate has a strong dependence on pH. There are two mechanisms for bicarbonate formation. In one case, first carbonic acid is formed

CO_{2(aq)}+H₂O→H₂CO_{3(aq)} followed by its decomposition

H₂CO₃+H₂O→H₃O⁺+HCO₃⁻

The carbonic acid formation step is relatively slow reaction without the presence of a catalyst.

At pH>8, a second mechanism is involved:

CO_{2(aq)}+OH⁻+HCO₃⁻, which has a fast reaction rate.

Both mechanisms then proceed to form calcium carbonate through the following steps:

HCO₃⁻+H₂O→H₃O⁺+CO₃⁻

Ca⁺⁺+CO₃⁻→CaCO₃

For pH>10, the second mechanism dominates, hence a high pH is optimal for CO₂ capture with a calcium hydroxide solution.

Therefore, in the CO₂ scrubber of the invention, the operational range of alkalinity for the calcium hydroxide solution is above pH 8.0, however the optimal operating range is above pH 10.0, so that the fast reaction, from dissolved CO₂ to the carbonate, dominates. In the calcium hydroxide solution, 0.8 grams of calcium hydroxide dissolved in one liter of water (0.8 gm/L) produces a solution of approximately pH 11.5. As CO₂ molecules combine with calcium ions and hydroxide ions, the pH of the solution is reduced. The capacity of the solution to absorb CO₂ is proportional to the pH of the solution. The optimal range for the alkalinity of the calcium hydroxide solution for removing gaseous CO₂ directly from the atmosphere is pH 11.0 to 11.5, in order to insure the fast reaction rate dominates the reaction with relatively low concentration of atmospheric CO₂. Post-process gases and post-combustion flue-gases can have high concentrations of gaseous CO₂, and can require high initial alkalinity to have the capacity to continue to absorb CO₂ by rapid reaction (above pH 10.0) for the time that the calcium hydroxide solution is in the reaction chamber.

Operating in the optimal alkalinity range of the CO₂ scrubber of the invention can result in scaling on all exposed parts. The Langelier Saturation Index (LSI) is probably the most widely used indicator of water scale potential. It is an equilibrium index and deals only with the thermodynamic driving force for calcium carbonate scale formation and growth. It indicates the driving force for scale formation and growth in terms of pH as a master variable. In order to calculate the LSI, it is necessary to know the alkalinity (mg/l as CaCO₃), the calcium hardness (mg/l Ca²⁺ as CaCO₃), the total dissolved solids (mg/l TDS), the actual pH, and the temperature of the water (° C.). If TDS is unknown, but conductivity is, one can estimate mg/L TDS. LSI is defined as:

LSI=pH−pHₛ

### Where:

pH is the measured water pH
pHₛ is the pH at saturation in calcite or calcium carbonate and is defined as:

pHₛ=(9.3+A+B)—(C+D)

### Where:

A=(Log₁₀ [TDS]−1)/10
B=−13.12×Log₁₀ (° C.+273)+34.55
C=Log₁₀ [Ca²⁺ as CaCO₃]−0.4
D=Log₁₀ [alkalinity as CaCO₃]

Since the alkalinity is kept high to enhance the transfer of CO₂ molecules from the mixed gases through the solution phase into calcium carbonate precipitants in suspension, the CO₂ scrubber of the invention is designed to minimize the opportunity for calcium deposits to form on the mechanical structure of the CO₂ scrubber. The mesh panel assemblies are the only point in the CO₂ scrubber where the calcium hydroxide solution comes together with the mixed gases, including gaseous CO2, within an intricate mechanical structure. The removable mesh-panel assemblies are designed to be removed and replaced during routine periodic maintenance. The mesh panels are cleaned with mild acid reassembled and replaced during the next scheduled routine maintenance. The CO₂ scrubber, from the top of the reaction chamber to the settling tank, has minimal mechanical structure to minimize opportunity for calcium deposits to form. The surface of the calcium hydroxide solution, at the bottom of the reaction chamber constitutes the top of the submarine portion of the reaction chamber, and at the bottom of the dewatering chamber, forms the top of the submarine portion of the dewatering tank. Precipitants in suspension in the froth matrix of the bubble column are deposited directly into the calcium hydroxide solution at the bottom of the reaction chamber and dewatering chamber to minimize opportunity for calcium deposits to form. Hydrodynamic currents and the slopes of the bottoms in the submarine portion of the dewatering chamber and the submarine portion of the reaction chamber, transport the precipitants to the settling tank. Thereby, the CO₂ scrubber of the invention is designed to minimize the opportunity for formation of calcium deposits.

The acceleration-of-gravity is incorporated to reduce the energy required by the froth generators to force the mixed gas stream and calcium hydroxide solution through the mesh panels. The saturated mesh panels of the froth generators are positioned with their bubble-producing area perpendicular to the linear axis of the reaction chamber, in order to incorporate the acceleration-of-gravity to partially force the mixed gases and calcium hydroxide solution through the mesh panels. When the reaction chamber is filled with bubbles, potential energy is stored in the column of bubbles. As the bubble column flows from the reaction chamber, the potential energy is partially converted to the kinetic energy of the bubble column flowing from the reaction chamber, and partially converted to the mixed gases and solution being drawn through the mesh panels of the froth generators, and the aqueous froth being drawn partially by low pressure into the reaction chamber. Thereby, the acceleration of gravity is incorporated to reduce the energy required by the CO₂ scrubber of the invention.

In the CO₂ scrubber of the invention, a continuous stream of mixed gases containing gaseous CO₂ and a continuous stream of calcium hydroxide solution are brought together to provide continuous carbon capture and sequestration. The CO₂ scrubber is designed to maximize the mass transfer of gaseous CO₂ from a mixed steam of gases into the calcium hydroxide solution.

The mass transfer between the CO₂ molecules in the gas stream and the calcium hydroxide solution is proportional to the solubility of CO₂. The solubility of CO₂ is influenced by several factors; the liquid-to-gas surface area, time of exposure between the CO₂ gas and the calcium hydroxide solution, the temperature of the liquid and the CO₂ gas, the CO₂ vapor 1 pressure in relation to the fluid pressure of the liquid, differential vapor pressure between adjacent bubbles of the froth, and the mean free path CO₂ molecules have to travel between collisions.

The liquid-to-gas surface area of the calcium hydroxide solution is exponentially increased by encapsulating the stream of mixed gases inside bubbles of calcium hydroxide solution. The calcium hydroxide solution is forced through mesh panel assemblies in the plurality of froth generators at the top of the reaction chamber. As the bubbles progress through the individual mesh panels of the mesh panel assembly, a portion of the bubbles burst and are reformed. Calcium-hydroxide micro-droplets with a wide distribution of radii that are formed by fragmentation of the bursting bubble walls and larger droplets, from aerodynamic friction with the gas stream, and calcium hydroxide vapor are included inside the bubbles as a portion of the bubbles reform while progressing through the mesh panels. The micro-droplets introduced into the bubbles by the bursting bubbles and fragmenting droplets in the froth generator include Kelvin-limit micro-droplets. The Kelvin limit for micro-droplets is the diameter at which micro-droplets are subject to irreversible evaporation from vapor loss due to extreme curvature of the micro-droplet surface. The relatively warm, dry, mixed gas stream vaporizes the Kelvin limit micro-droplets inside the bubbles, increasing the vapor pressure inside the bubbles.

The wet interior and exterior surfaces of the bubbles and the surface area of the micro-droplets provide the primary areas for inter-phase transport for gas molecules between the gas stream and the calcium hydroxide solution. The size of the bubbles is limited by the size of the openings in the mesh panels. The stream of mixed gases, the calcium hydroxide solution, and small openings in the mesh panels produce a myriad of uniformly small bubbles.

The time-of-exposure between the CO₂ in the gas stream and the calcium hydroxide solution is maximized by encapsulating the mixed gases, including gaseous CO₂ inside bubbles of calcium hydroxide solution. Discrete volumes of mixed gas are contained inside the bubbles of calcium hydroxide solution from the froth generators at the top of the reaction chamber until the bubbles are burst by the spray of droplets in the dewatering chamber.

The solubility of CO₂ is inversely proportional to temperature. When the bubbles are formed, the discrete volume of relative hot dry mixed gas encapsulated inside the bubble vaporizes the Kelvin limit droplets. The water in the calcium hydroxide solution expands to 1600 times its volume when it vaporizes. The sensible heat of the relative hot gas is converted to the latent heat required to separate the calcium-hydroxide solution molecules from the liquid physical state to a gaseous physical state. In addition, a heat exchanger cools the calcium hydroxide solution before the solution is introduced to the froth generators, in order to increase the solubility of CO₂. The warm dry gas is cooled inside the bubbles by the cooled calcium hydroxide solution that constitutes the froth matrix; the intersecting intercellular walls and intersecting border junctions of adjacent bubbles in a column of bubbles. As the mixed gases inside the bubbles cool, condensing vapor has an affinity for similar liquid surfaces and increases the mass and diameter of the micro-droplets in the air, inside the bubbles.

The solubility of CO₂ is proportional to pressure. Vapor pressure inside each bubble is increased to increase solubility of CO₂ into the calcium hydroxide solution. When vapor pressure of the gas over a liquid is higher than the hydrostatic pressure of the liquid, more molecules are absorbed by the liquid than can escape from the liquid, and the concentration of the gas in the liquid increases over time. Kelvin-limit micro-droplets are vaporized by the relative hot and dry mixed gas inside the bubbles. The water inside the calcium hydroxide solution expands to 1600 times its volume inside the bubble, increasing vapor pressure inside the bubble.

The vertical column of froth produces a vertical pressure gradient that increases as the bubbles are carried downward by the flow of the bubble column. The increasing pressure reduces the bubble radius, and increases the vapor pressure inside the bubbles. In addition, Pierre LaPlace (1749-1847) teaches that the vapor pressure inside the bubble is proportional to the surface tension of the bubble wall, and is inversely proportional to the radius (LaPlace's Law for bubbles). The smaller the bubble radius, the higher the vapor pressure inside the bubble. As the diameters of the bubbles are reduced due to increasing ambient pressure, the vapor pressure inside the bubbles is increased. An inherent benefit to using a calcium-hydroxide aqueous froth to separate CO₂ from a mixture of gases is that the pressure differences between the cells of foam drive the diffusion of gas through the cell walls (leading to coarsening of the foam structure). The smaller bubbles, with higher vapor pressure, diffuse their volume of gas through the cell wall into the larger bubbles. The CO₂ scrubber of the invention has an advantage over prior art by incorporating the additional increase in vapor pressure inside the bubbles, and the diffusion of gas through the bubble walls, as described by LaPlace's Law. Vapor pressure inside each bubble is increased to increase solubility of CO₂ into the calcium hydroxide solution.

The reduced radius of the bubble, due to increasing ambient pressure, combined with the growing surface area of the micro-droplets inside the bubbles due to condensation, reduces the volume available to the gas inside the bubbles, thereby reducing the mean-free-paths the CO₂ molecules have to travel between collisions. As the mean-free-path of the molecules is decreased, the rate of collisions between the CO₂ molecules and the surface of the calcium hydroxide solution increases, increasing the rate of dissolution of CO₂ into the calcium hydroxide solution.

CO₂ is water soluble and dissolves into an aqueous solution up to a saturation point. In an aqueous calcium-hydroxide solution, the dissolved CO₂ reacts with the calcium ions and hydroxide ions in solution forming insoluble calcium carbonate. The calcium carbonate precipitates out of solution, into suspension. As the dissolved CO₂ reacts with calcium ions and hydroxide ions in solution, the dissolved CO₂ is removed from solution allowing more gaseous CO₂ to be dissolved into the calcium hydroxide solution. The dissolution of CO₂, the reaction of CO₂ molecules with calcium ions and hydroxide ions in solution, and the precipitation of calcium carbonate out of solution prevents CO₂ from saturating the solution. CO₂ molecules pass from the gas stream through the liquid phase to solid calcium carbonate precipitants in suspension, and allows for continuous dissolution of gaseous CO₂ into the calcium hydroxide solution.

Thereby, the CO₂ scrubber of the present invention maximizes the solubility of CO₂ into the calcium hydroxide solution in order to maximize the capture of gaseous CO₂ from a mixture of gases.

The precipitation of calcium carbonate into suspension realizes the capture of gaseous CO₂ from a collection of mixed gases and long-term mineral sequestration of the captured CO₂ from the atmosphere. The fine precipitant suspension and coarse precipitant slurry are further processed to separate the calcium carbonate precipitants from the solution.

CCS System with Precipitant Processing

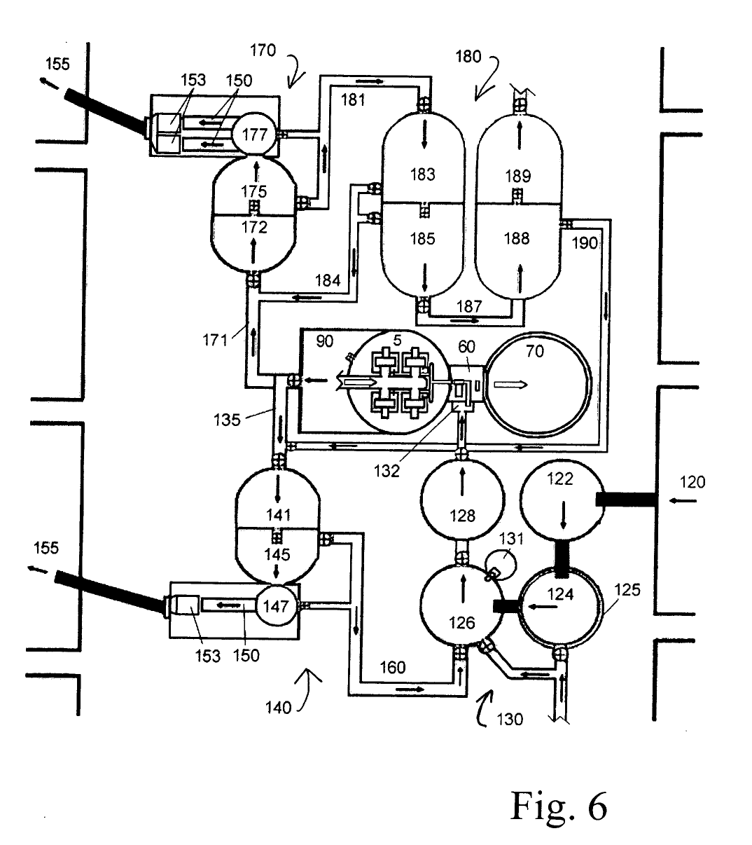

In the CCS system with precipitant processing FIG. 6, calcium oxide is supplied from a rail car 120 by conveyor belt to the to a calcium oxide holding bin 122, in the solution preparation area 130. The calcium oxide is conveyed to a calcium hydroxide mixing tank 124 where it's slaked with water to produce calcium hydroxide (solid). Heat from the exothermic reaction is used to dry the precipitants in the final precipitant processing stage. Waste heat is released through the exhaust stack 70.

The calcium hydroxide is conveyed to a replenishment tank 126 where calcium hydroxide solution is mixed, the pH and surfactant levels 131 are adjusted to the optimal operational range, and the main solution return flow 160 is recycled back to the replenishment tank 126.

The calcium hydroxide solution flows from the replenishment tank 126 to the calcium hydroxide operational reservoir 128. The calcium hydroxide solution in the operational reservoir 128 has had alkalinity and surfactant level replenished, and is piped to a heat exchanger 132 adjacent to the dewatering chamber 60. The solution is pumped from the heat exchanger 132 to the calcium hydroxide solution pump, through the vertical solution supply pipe up to the solution distribution manifold, located on the top of the reaction chamber of the CO₂ scrubber 5. The calcium hydroxide solution is combined with the mixed gas stream in the mesh panel assemblies of the froth generators to produce a column of calcium-hydroxide bubbles in the reaction chamber.

The bubble column fills the reaction chamber and reacts with CO₂ forming calcium carbonate precipitants. The calcium carbonate precipitants are carried from the reaction chamber, in suspension in the bubble walls, into the dewatering chamber 60. The gases that are released from the bubbles, as the bubbles are dewatered, are released to the atmosphere through the exhaust stack 70. The precipitants are washed into the submarine portion of the dewatering chamber 60 by the projectile spray of droplets from the spray nozzles. Hydrodynamic currents in the submarine portion of the dewatering chamber 60 and in the submarine portion of the reaction chamber carry the precipitants in suspension into the settling tank 90. In the settling tank 90, the massive precipitants settle into a slurry channel in the bottom of the tank, the less massive precipitants remain in suspension.

The less-massive precipitant suspension flows from the settling tank 90 through the main solution flow pipe 102 to the receiving tank 141 in the fine-precipitant processing area 140. The fine-precipitant processing functions in continuous mode, where the fine precipitant suspension flows from the receiving tank 141, into a froth flotation tank 145. Compressed air introduced into a plurality of nozzles (not shown) at the bottom of the tank fills the froth flotation tank 145 with bubbles. A portion of the precipitants suspended in the solution are carried by the bubbles into an aqueous froth on top of the flotation tank 145. The bubbles are directed by the shape of the top of the tank into the receiving vat 147. Spray nozzles in the top of the receiving vat 147 dewater the bubbles, and channel the remaining fine precipitant slurry through a funnel portion of the receiving vat 147 into a Siemens model J-VAC, combination high-bar diaphragm-plate filter press/vacuum dryer 150. The solution is pressed from slurry in the filter press 150 forming filter cakes. The hot water from the heat exchanger 125 around the calcium hydroxide mixing tank 124 heats air to approximately 80° C. The hot air is drawn through the filter cakes to dry them by partial vacuum. The filter cake is transferred from the filter press 150 to the Siemens rotating-cylinder tumble dryer 153. The hot water from the heat exchanger 125 around the calcium hydroxide mixing tank 124 heats the air in the tumble dryer 153 to approximately 80° C. The filter cake dried further and tumbled to separate individual granules. The dried, fine precipitants are conveyed to a rail car 155 for sale or recycling.

The main calcium-hydroxide solution flow flows from the froth flotation tank 145 and into the main solution return pipe 160. The solution flows through the main solution return pipe 160 to the replenishment tank 126. The flow of solution pressed from the slurry to form the filter cakes flows into the fine slurry solution return pipe, into the main solution return pipe 160, and then to the replenishment tank 126. The alkalinity, surfactant concentration are adjusted to the optimal range and the calcium hydroxide solution is recycled back through the system.

The coarse precipitant slurry is forced out of the slurry outlet portal 103 in the bottom of the settling tank 90, through the slurry pipe 171, into the primary receiving tank 172 in the coarse precipitant processing area 170. Coarse precipitant processing functions in batch mode; the receiving tank 172 is partially filled over time by the flow from the settling tank 90 and then empties the volume of slurry in the into the coarse-slurry settling tank 175. The coarse precipitants settle out of the slurry, into concentrated slurry that is pumped to the receiving vat 177. The concentrated coarse-precipitant slurry flows from the receiving vat 177 through a bifurcated funnel portion of the receiving vat 177 into one of two Siemens model J-VAC, combination high-bar diaphragm-plate filter press/vacuum dryers 150. The filter presses operate simultaneously provides two paths for the dewatering and drying of the coarse precipitant slurry. The solution is pressed from the filter cakes. The hot water from the heat exchanger 125 around the calcium hydroxide mixing tank 124 heats air to approximately 80° C. The hot air is drawn through the filter cakes to dry them. The filter cake is transferred from the filter press 150 to the one of two Siemens rotating-cylinder tumble dryers 153. The hot water from the heat exchanger 125 around the calcium-hydroxide mixing tank 124 heats the air in the tumble dryer 153 to approximately 80° C. The filter cake is dried further and tumbled to separate individual granules. The dried, coarse precipitants are conveyed to a rail car 155 for sale or recycling.

The calcium-hydroxide solution from the coarse-precipitant slurry flows from the slurry settling tank 175, and into the secondary processing pipe 181. The flow of solution pressed from the slurry to form the filter cakes flows through into the slurry solution return pipe, into the secondary processing pipe 181, and then to the secondary processing receiving tank 183. Secondary slurry processing 180 operates in batch mode; the receiving tank 183 is mostly filled over time by the flow of solution from the slurry settling tank 175 and then empties the volume of solution into the secondary coarse-slurry settling tank 185. Massive precipitants that settle of the solution while the secondary receiving tank 183 is being filled are forced, by hydrostatic pressure, through a slurry return pipe 184 to the primary coarse-precipitant slurry receiving tank 172. The volume of solution from the secondary receiving tank 183 is mostly transferred to the secondary settling tank 185 when the secondary receiving tank 183 is partially filled. The coarse precipitants that settle out of solution in the secondary settling tank 185 are forced, by hydrostatic pressure, through the slurry return pipe 184 to the primary coarse-precipitant slurry receiving tank 172. When the volume of solution mostly fills the secondary receiving tank 183, the volume of solution, with fine precipitants in suspension, from the secondary settling tank 185 is mostly transferred through the solution transfer pipe 187 to the high pH tank 188 in preparation for the iterative transfer of solution from the secondary receiving tank 183, into the secondary settling tank 185. The solution, with fine precipitants in suspension, in the high pH tank 188 is transferred through the secondary solution return pipe 190 to the main solution flow pipe 135 at the beginning of the fine-precipitant processing area 140. The fine-precipitant suspension from the high pH tank 188 is processed with the main flow of fine-precipitant suspension from the settling tank 90 in the CO₂ scrubber 5. In the low pH tank 189, the alkalinity is adjusted to approximately pH 7.0, for water that is returned to the environment.

The calcium carbonate precipitants are sold for mineral filler, acidic soil neutralization, slope stabilization, flow-able fill, and as admix for Portland cement. In purified form, Precipitated Calcium Carbonates (PCCs) are used for the production of paper, plastics, food, and medicine. The recycling or sale of calcium carbonate commodities from recovered CO₂ offset, at least a portion of, the cost of CCS.

### ALTERNATIVE EMBODIMENTS

Although the preferred form of the invention cools the bubbles as they move downwardly in the reaction chamber a less preferred form of the invention may be practiced without cooling the bubbles or the solution.

The CO₂ scrubber of the invention can optionally incorporate a sodium hydroxide solution or a mixture of alkali earth metal hydroxide solutions for CCS. Sodium hydroxide is produced by the Chlor-Alkali Process, by the electrolysis of an aqueous sodium chloride solution. When the CO₂ scrubber is used with a sodium hydroxide solution, the product of reaction is sodium bicarbonates. Potassium hydroxide may be added to the calcium or sodium hydroxide solutions to accelerate, catalyze, or enhance the reaction.

The CO₂ scrubber of the invention can be used with an aqueous calcium-carbonate suspension for Flue-Gas Desulfurization (FGD). When forced air is sparged into the submarine portion of the reaction chamber, the product of reaction is calcium sulfate. When the CO₂ scrubber is used in combination with an FGD, the FGD removes the sulfuric acid from the mixed gases that would inhibit the precipitation of calcium carbonate in the CO₂ scrubber, and the gaseous CO₂ released from the reaction between calcium carbonate suspension and sulfuric acid in the FGD is carried in the mixed gas stream to the CO₂ scrubber. The calcium carbonate precipitants from the CCS process can be used to produce the aqueous calcium-carbonate suspension for the FGD.

### CONCLUSIONS, RAMIFICATIONS, AND SCOPE

### Conclusions

The CO₂ scrubber of the invention includes the following functions and features to increase the removal efficiency of gaseous CO₂ from a mixture of gases over the prior art.

The liquid-to-gas surface area of a calcium hydroxide solution, between gaseous CO₂ in a stream of mixed gases and the calcium-hydroxide solution, is increased exponentially to facilitate mass transfer between the CO₂ gas and the calcium hydroxide solution.

The flue gas stream is encapsulated in bubbles to increase time-of-contact between gaseous CO₂ in a stream of mixed gases and calcium hydroxide solution to facilitate mass transfer between the CO₂ gas and the calcium hydroxide solution.

Cause at least some of the bubbles to burst and reform, the bursting bubbles forming numerous micro-droplets having various radii, wherein each reforming bubble encapsulates a discrete volume of the mixed gas stream, a discrete number of the solution micro-droplets, and a discrete volume of solution vapor.

The temperature of the calcium hydroxide solution is decreased to increase solubility of gaseous CO₂ into the calcium hydroxide solution.

The CO₂ vapor pressure inside the bubbles is increased to increase solubility of the gaseous CO₂ into the calcium hydroxide solution.

The mixed gas, including gaseous CO₂, is diffused through a common cell wall of calcium hydroxide solution, between two bubbles of differential pressure, from the relative smaller bubble with higher vapor pressure into the relative larger bubble with lower vapor pressure.

Calcium hydroxide is used for the alkali solution to react with the gaseous CO₂ in order to recover calcium carbonate as a product of reaction.

Recovered CO₂ is recycled as calcium carbonate commodities to be sold to recover at least a portion of the cost of CCS.

### Ramifications

The CO₂ scrubber of the invention can remove CO₂ directly from the atmosphere, post combustion flue gas, and processes that release CO₂ as a result of the process, or the result of production.

The CO₂ scrubber of the invention can incorporate other alkali earth-metal hydroxide solutions or a mixture of alkali earth-metal hydroxide solutions for CCS.

The CO₂ scrubber of the invention can incorporate an aqueous calcium-carbonate suspension for Flue-gas desulfurization (FGD). When forced air is sparged into the submarine portion of the reaction chamber, the product of reaction is calcium sulfate (gypsum). FGD gypsum is used to manufacture cement and gypsum panels.

The CO₂ scrubber of the invention can be integrated with an FGD to remove SOx and CO₂ from a stream of mixed gases. An aqueous calcium-carbonate suspension can be produced from the calcium carbonate precipitants that are the product of reaction in the CO₂ scrubber, and the CO₂ gas released during the reaction between the calcium carbonate precipitants and sulfuric acid in the FGD is carried in the mixed gas stream to the CO₂ scrubber.

### Scope

The exemplary process and devices described above have been presented for purposes of illustration and description and are not intended to be exhaustive or limit the scope of the invention to the precise form disclosed. Modifications and variations are possible in the light of the above teaching. The embodiments were chosen to best explain the invention and its practical application to thereby enable others, skilled in the art to best use the invention in various embodiments and with various modifications suited to the particular use contemplated.

The scope of the invention is to be defined by the following claims:

What is claimed is:

1. A method of capturing and sequestering gaseous carbon dioxide (CO₂) from a mixed gas stream, wherein a reaction chamber is utilized and a mesh panel assembly in said reaction chamber has a plurality of mesh openings, comprising the steps:
continuously saturating said mesh assembly, having a plurality of mesh panels, with a solution containing calcium ions (Ca++) and hydroxide ions (OH−),
passing said gas stream, having gaseous CO₂, through said saturated mesh assembly to form an aqueous froth wherein the bubbles of said froth have their interior volumes filled with said mixed gases
causing at least some of said bubbles to burst and reform, said bursting bubbles forming numerous micro-droplets having various radii, wherein each reforming bubble encapsulates a discrete volume of said gas stream, a discrete number of said solution micro-droplets, and a discrete volume of solution vapor,
limiting the size of said bubbles formed in said aqueous froth by limiting the size of the openings in said mesh panels, and thereby forming a myriad of uniformly small bubbles, thereby maximizing the contact between said CO₂ molecules, said micro-droplets, and the inner and outer surfaces of said myriad of small bubbles,
cooling said solution before it flows through said saturated mesh panels and cooling said gas inside said bubbles as the bubbles moves downwardly through said reaction chamber,
causing said aqueous froth and said gas stream to move together downwardly through said reaction chamber to increase the reaction time between said gas stream and said myriad of bubbles, and to increase the pressure of said aqueous froth, thereby decreasing the size of said bubbles and increasing solubility of CO₂ molecules into said solution,
minimizing the mean free path of CO₂ molecules inside said bubbles by decreasing the volume of said bubbles to reduce the distance between said inner surfaces of each bubble and said micro-droplets inside each bubble, thereby maximizing contact between said CO₂ molecules and said solution used to form said bubbles and said micro-droplets,
capturing CO₂ molecules carried in said solution by the reaction of said CO₂ molecules with said calcium ions (Ca++) and hydroxide ions (OH−) in said solution to form calcium carbonate (CaCO₃) molecules, and
precipitating said calcium carbonate out of said solution.

2. The method of claim 1 comprising the further step:
cooling said solution before it flows through said saturated mesh panels.

3. The method of claim 1 wherein said reaction chamber is an elongated, vertically oriented chamber having a bottom portion in fluid communication with a horizontal dewatering chamber, and wherein an adjustable outlet panel changes the size of the opening between the reaction and dewatering chambers, comprising the further step:
adjustably changing the size of the opening between the lower portion of said reaction chamber and said dewatering chamber.

4. The method of claim 3 comprising the further steps:
dewatering said aqueous froth in said dewatering chamber, and
discharging said dewatered gas stream into the atmosphere.

5. The method of claim 1 wherein a settling tank is positioned below said reaction chamber, comprising the further step:
causing said precipitated calcium carbonate to settle downwardly by gravity into said settling tank.

6. The method of claim 5 comprising the further step of continuously removing said precipitated calcium carbonate from said settling tank.

7. The method of claim 1 comprising the further step of separating sulfur from said gas stream by reacting said sulfur with said calcium carbonate in suspension.

8. A method of capturing and sequestering gaseous carbon dioxide (CO₂) from a mixed gas stream, wherein a reaction chamber is utilized and a mesh panel assembly in said reaction chamber has a plurality of mesh openings, comprising the steps:
continuously saturating said mesh assembly, having a plurality of mesh panels, with a solution containing calcium ions (Ca++) and hydroxide ions (OH−),
passing said gas stream, having gaseous CO₂, through said saturated mesh assembly to form an aqueous froth wherein the bubbles of said froth have their interior volumes filled with said mixed gases
causing at least some of said bubbles to burst and reform, said bursting bubbles forming numerous micro-droplets having various radii, wherein each reforming bubble encapsulates a discrete volume of said gas stream, a discrete number of said solution micro-droplets, and a discrete volume of solution vapor,
limiting the size of said bubbles formed in said aqueous froth by limiting the size of the openings in said mesh panels, and thereby forming a myriad of uniformly small bubbles, thereby maximizing the contact between said CO₂ molecules, said micro-droplets, and the inner and outer surfaces of said myriad of small bubbles,
causing said aqueous froth and said gas stream to move together downwardly through said reaction chamber to increase the reaction time between said gas stream and said myriad of bubbles, and to increase the pressure of said aqueous froth, thereby decreasing the size of said bubbles and increasing solubility of CO₂ molecules into said solution,
minimizing the mean free path of CO₂ molecules inside said bubbles by decreasing the volume of said bubbles to reduce the distance between said inner surfaces of each bubble and said micro-droplets inside each bubble, thereby maximizing contact between said CO₂ molecules and said solution used to form said bubbles and said micro-droplets,
capturing CO₂ molecules carried in said solution by the reaction of said CO₂ molecules with said calcium ions (Ca++) and hydroxide ions (OH−) in said solution to form calcium carbonate (CaCO₃) molecules, and
precipitating said calcium carbonate out of said solution.

9. The method of claim 8 comprising the further step of cooling said myriad of bubbles as the bubbles move downwardly through said reaction chamber.

10. The method of claim 8 wherein said solution is cooled before it passes through said mesh panels.

11. The method of claim 8 wherein said solution includes calcium hydroxide and an alkali earth metal hydroxide.

12. A method of capturing and sequestering gaseous carbon dioxide (CO₂) from a mixed gas stream, wherein a reaction chamber is utilized and a mesh panel assembly in said reaction chamber has a plurality of mesh openings, comprising the steps:
continuously saturating said mesh assembly, having a plurality of mesh panels, with a sodium hydroxide solution,
passing said gas stream, having gaseous CO₂, through said saturated mesh assembly to form an aqueous froth wherein the bubbles of said froth have their interior volumes filled with said mixed gases
causing at least some of said bubbles to burst and reform, said bursting bubbles forming numerous micro-droplets having various radii, wherein each reforming bubble encapsulates a discrete volume of said gas stream, a discrete number of said solution micro-droplets, and a discrete volume of solution vapor,
limiting the size of said bubbles formed in said aqueous froth by limiting the size of the openings in said mesh panels, and thereby forming a myriad of uniformly small bubbles, thereby maximizing the contact between said CO₂ molecules, said micro-droplets, and the inner and outer surfaces of said myriad of small bubbles,
causing said aqueous froth and said gas stream to move together downwardly through said reaction chamber to increase the reaction time between said gas stream and said myriad of bubbles, and to increase the pressure of said aqueous froth, thereby decreasing the size of said bubbles and increasing solubility of CO₂ molecules into said solution,
minimizing the mean free path of CO₂ molecules inside said bubbles by decreasing the volume of said bubbles to reduce the distance between said inner surfaces of each bubble and said micro-droplets inside each bubble, thereby maximizing contact between said CO₂ molecules and said solution used to form said bubbles and said micro-droplets,
capturing CO₂ molecules carried in said solution by the reaction of said CO₂ molecules with said sodium hydroxide solution to form sodium bicarbonate molecules, and
precipitating said sodium bicarbonate out of said solution.

13. The method of claim 12 comprising the further step of cooling said myriad of bubbles as the bubbles move downwardly through said reaction chamber.

14. Apparatus for capturing and sequestering gaseous carbon dioxide CO₂ from a mixed gas stream, wherein calcium ions and hydroxide ions react with carbon dioxide to form calcium carbonate as a precipitate, comprising:
a vertically extending reaction chamber having upper and lower sections,
an array of mesh panels positioned at said upper section of said reaction chamber,
means for continuously saturating said mesh panels with a solution containing calcium or sodium ions and hydroxide ions,
forth generator means positioned above said array of mesh panels,
a duct carrying said mixed gas stream into said froth generator means,
whereby said froth generator means forms an aqueous froth having a myriad of small bubbles wherein the interior volumes of said bubbles are filled with gas from said mixed gas stream containing gaseous carbon dioxide,
means for cooling said aqueous froth,
means for pressurizing said aqueous froth to reduce the size of said myriad of bubbles as said froth moves to said lower section of said reaction chamber, and
settling tank means below said reaction chamber for collecting calcium carbonate or sodium bicarbonate precipitates.
